(19) United States
(12) Patent Application Publication
(10) Pub. No.: US 2023/0222512 A1
(43) Pub. Date: Jul. 13, 2023

(54) SUPPORT SYSTEM, SUPPORT METHOD, AND SUPPORT PROGRAM

(71) Applicant: Nomura Research Institute, Ltd., Tokyo (JP)

(72) Inventor: Fumiya MUTO, Tokyo (JP)

(21) Appl. No.: 17/902,084

(22) Filed: Sep. 2, 2022

(30) Foreign Application Priority Data
Jan. 12, 2022 (JP) 2022-002906

(51) Int. Cl. G06Q 30/00; G06Q 30/02; G06Q 20/38

(52) U.S. Cl. CPC G06Q 30/016; G06Q 30/0259; G06Q 20/389

(57) ABSTRACT

A support system including: a user information acquisition unit that acquires, from a first system that is an external information processing system, user information including payment method information regarding a payment method when a user purchases a product or service and support recipient information indicating a support recipient for which the user desires support; a purchase information acquisition unit that acquires, from the payment system that manages purchase information, the purchase information regarding purchase of the product or service by the user in the payment method; and a support execution information generation unit that generates support execution information in which the support recipient information, support goods information, and affiliated store information are associated with each other, based on the user information, the purchase information, and a preset correspondence among product-or-the-like information indicating the product or the service, the support goods information, and the affiliated store information.

### BACKGROUND OF THE INVENTION

### 1. Technical Field

The present invention relates to a support system, a support method, and a support program.

### 2. Description of the Related Art

Conventionally, in order to support a specific person or group, a consumer directly or indirectly performs support activities for the specific person or group through contribution of goods or money, purchase of a specific product, participation in an activity of the group, or the like.

In recent years, in order to make support activities of a consumer more active, a method in which a consumer supplies support corresponding to a purchase amount when the consumer purchases a product or a service has become known.

For example, Japanese Patent No. 4550592 discloses a device including a unit that causes a consumer to designate a contribution recipient desired by the consumer from a contribution recipient list when the consumer purchases a product, and makes a contribution of an amount corresponding to a purchase amount to the designated contribution recipient.

### SUMMARY OF THE INVENTION

However, in the device disclosed in Japanese Patent No. 4550592, effective utilization of data regarding support activities is insufficient.

Accordingly, an objective of the present invention is to supply a support system, a support method, and a support program capable of implementing effective utilization of data regarding a support activity.

According to an aspect of the present invention, a support system includes: a user information acquisition unit configured to acquire, from a first system that is an external information processing system, user information including payment method information regarding a payment method when a user purchases a product or service and support recipient information indicating a support recipient for which the user desires support; a purchase information acquisition unit configured to acquire purchase information regarding purchase of a product or a service by the user in accordance with the payment method from a payment system that manages the purchase information; and a support execution information generation unit configured to generate support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.

According to another aspect of the present invention, a support method includes: by a computer, acquiring, from a first system that is an external information processing system, user information including payment method information regarding a payment method when a user purchases a product or service and support recipient information indicating a support recipient for which the user desires support; acquiring purchase information regarding purchase of a product or a service by the user in accordance with the payment method from a payment system that manages the purchase information; and generating support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.

According to still another aspect of the present invention, a support program causes a computer to implement: a user information acquisition unit configured to acquire, from a first system that is an external information processing system, user information including payment method information regarding a payment method when a user purchases a product or service and support recipient information indicating a support recipient for which the user desires support; a purchase information acquisition unit configured to acquire purchase information regarding purchase of a product or a service by the user in accordance with the payment method from a payment system that manages the purchase information; and a support execution information generation unit configured to generate support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.

In the present invention, a “unit” does not simply mean a physical unit, but includes a case where a function of the “unit” is realized by software. Functions of one “unit” or device may be implemented by two or more physical units or devices, or functions of two “units” “units” or devices may be implemented by one physical unit or device.

According to the present invention, it is possible to supply a support system, a support method, and a support program capable of implementing effective utilization of data regarding a support activity.

### BRIEF DESCRIPTION OF THE DRAWINGS

FIG. 1 is a diagram illustrating a configuration of a support system according to an embodiment of the present invention;

FIG. 2 is a diagram illustrating an example of information stored in a user information storage unit;

FIG. 3 is a diagram illustrating an example of information stored in an affiliated store information storage unit;

FIG. 4 is a diagram illustrating an example of information stored in a correspondence storage unit;

FIG. 5 is a diagram illustrating an example of information stored in a purchase information storage unit;

FIG. 6 is a diagram illustrating an example of information stored in a support execution information storage unit;

FIG. 7 is a diagram illustrating an example of information stored in a support result information storage unit;

FIG. 8 is a flowchart illustrating an example of a process in the support system; and

FIG. 9 is a flowchart illustrating an example of a process in the support system.

### DETAILED DESCRIPTION

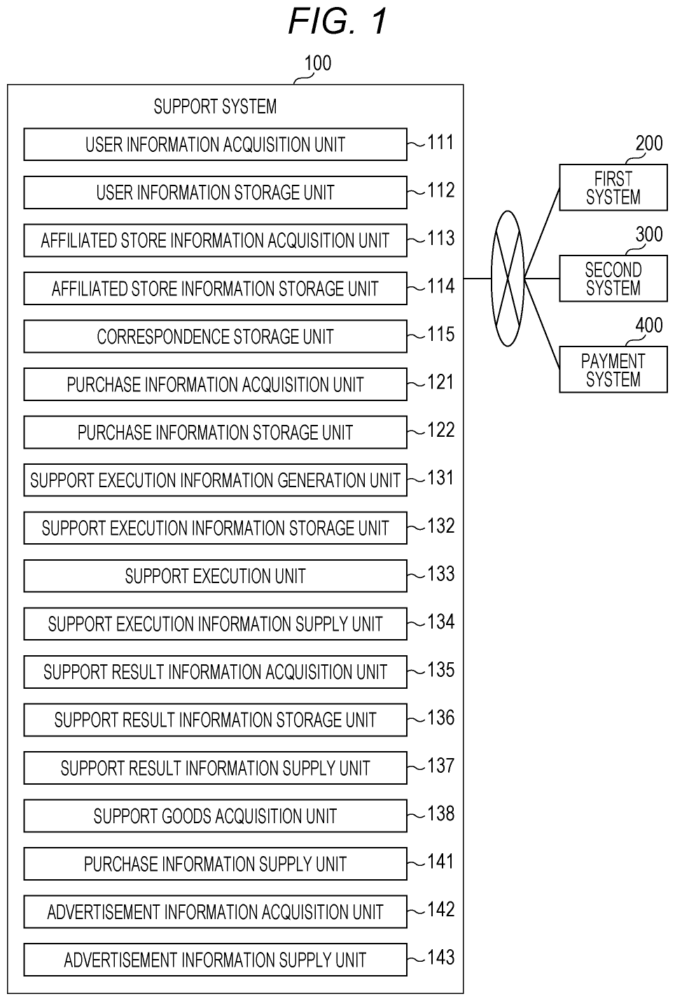

Preferred embodiments of the present invention will be described with reference to the accompanying drawings. FIG. 1 is a diagram illustrating a configuration of a support system 100 according to an embodiment of the present invention.

The support system 100 is a system communicatively connected to a first system 200, a second system 300, and a payment system 400 which are external information processing systems via a network such as the Internet.

The support system 100 is a system used when support goods are supplied to support recipients to which users desire support. Here, the users are, for example, consumers who use the support system 100. The support includes supplying a predetermined support recipient with support goods corresponding to purchase of a specific product or service, participation in a specific activity, or the like. That is, for example, when the user using the support system 100 purchases a specific product, the user can supply support goods corresponding to the product to a support recipient for which the user desires support through the support system 100. The details of the support system 100 will be described below.

The first system 200 is, for example, an information processing system that is used by a user. The information processing system that is used by the user is, for example, an information processing system that controls a user terminal or a service (for example, a web service such as crowdfunding, an interaction site, or the like) that is used by the user. The first system 200 acquires, based on an input by the user, user information including payment method information regarding a payment method when the user purchases a product or service and support recipient information indicating a support recipient for which the user desires support, and supplies the user information to the support system 100.

The second system 300 is, for example, an information processing system of an affiliated store using the support system 100, and is, for example, an information processing system that is managed by a manufacturer, a seller, or the like of a product or the like purchased by the user. The second system 300 may be a system that executes support based on the support execution information supplied from the support system 100 or may be a system that supplies the support execution information to another information processing system.

The payment system 400 is an information processing system that manages purchase information regarding purchase of a product or the like by a user, and is, for example, a system that is managed by a retail store or the like. For example, when the user purchases a product or the like at a retail store, purchase information is generated and managed by the payment system 400. The payment system 400 supplies the purchase information to the support system 100. The second system 300 and the payment system 400 may be or may not be an information processing system managed by the same affiliated store.

Next, the details of the support system 100 will be described. The support system 100 includes a user information acquisition unit 111, a user information storage unit 112, an affiliated store information acquisition unit 113, an affiliated store information storage unit 114, a correspondence storage unit 115, a purchase information acquisition unit 121, a purchase information storage unit 122, a support execution information generation unit 131, a support execution information storage unit 132, a support execution unit 133, a support execution information supply unit 134, a support result information acquisition unit 135, a support result information storage unit 136, a support result information supply unit 137, a support goods acquisition unit 138, a purchase information supply unit 141, an advertisement information acquisition unit 142, and an advertisement information supply unit 143. A computer included in the support system 100 includes a processor and a storage area. Each unit illustrated in FIG. 1 can be implemented, for example, by using a storage area or causing a processor to execute a program stored in the storage area.

The user information acquisition unit 111 acquires user information regarding a user who uses the support system 100 from the first system 200 and stores the user information in the user information storage unit 112. Here, the user information includes payment method information regarding a payment method when the user purchases a product or service and support recipient information indicating a support recipient for which the user desires support.

The payment method information is information regarding a payment method for the user, and is, for example, information including a type of payment method (for example, a credit card, an IC card, or the like), the number of a credit card, an IC card, or the like, and the number of a member card presented at the time of payment. That is, when the user makes a payment using a credit card, an IC card, or the like, the support system 100 specifies the corresponding user based on, for example, the number of the credit card, the IC card, or the like. When the user makes a payment in cash without using a credit card, an IC card, or the like, the support system 100 specifies the corresponding user based on, for example, the number of the member card presented at the time of payment.

The payment method information may be any information regarding the payment method of capable of specifying the user who uses the support system 100. For example, a timing of payment (prepayment, post-payment, immediate payment, or the like) and the type of payment method (credit card payment, electronic money payment, point payment, bank transfer, cash payment, or the like.) are not limited.

The support recipient information is information indicating a support recipient for which the user desires support and may be, for example, information indicating an organization name of the support recipient. Here, the support recipient may be an organization or an individual who performs a specific activity. That is, the support recipient may be, for example, a charitable organization that supports the socially vulnerable or may be a group or an individual (for example, an idol group, a member of the idol group, a cartoon artist, or the like.) that performs entertainment activities.

A plurality of pieces of payment method information may be associated with one user and different pieces of support recipient information may be set for each of the plurality of pieces of payment method information.

The user information acquisition unit 111 may acquire the payment method information and the support recipient information at any timing before the support execution information is generated by the support execution information generation unit 131 to be described below. That is, in the support system 100, the purchase information may be acquired by the purchase information acquisition unit 121 after the payment method information is acquired by the user information acquisition unit 111. Thereafter, the support recipient information may be acquired by the user information acquisition unit 111. In the support system 100, the purchase information may be acquired by the purchase information acquisition unit 121 after the payment method information and the support recipient information are acquired by the user information acquisition unit 111. The payment method information and the support recipient information may be acquired by the user information acquisition unit 111 after the purchase information is acquired by the purchase information acquisition unit 121.

The user information acquisition unit 111 can acquire the user information from the user terminal. In this case, for example, after the user inputs the user information on a dedicated input form through the user terminal, the user information acquisition unit 111 acquires the input user information.

The user information acquisition unit 111 can acquire the user information from an information processing system different from the user terminal. In this case, for example, the user supplies the user information to an information processing system different from the user terminal in advance by performing an input through the user terminal and the user information acquisition unit 111 acquires the user information. Here, the information processing system different from the user terminal may be an information processing system used by the user and may be, for example, an information processing system that supplies a web service such as crowdfunding, an interaction site, or the like.

The user information acquisition unit 111 may acquire the user information in such a manner that a predetermined person in charge inputs the user information received on paper from the user when the support system 100 is used.

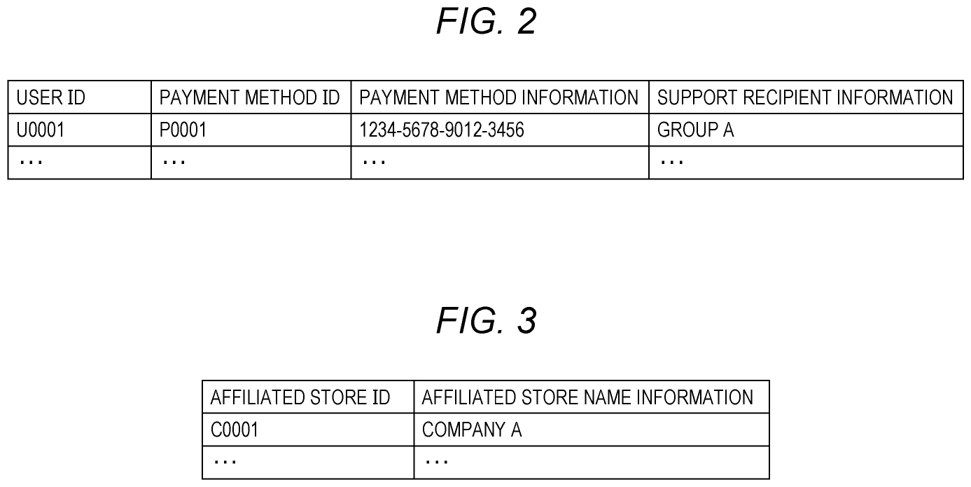

FIG. 2 is a diagram illustrating an example of information stored in the user information storage unit 112. The information stored in the user information storage unit 112 includes, for example, a user ID, a payment method ID, payment method information, and support recipient information. Here, the user ID is user identification information for identifying a user who uses the support system 100. The payment method ID is information for identifying the payment method information.

The affiliated store information acquisition unit 113 acquires the affiliated store information regarding an affiliated store who uses the support system 100 from the second system 300, and stores the affiliated store information in the affiliated store information storage unit 114.

Here, the affiliated store using the support system 100 is, for example, a manufacturer or a seller of a product or the like purchased by the user. In response to a process of the support system 100 based on the purchase information of a product or the like corresponding to the affiliated store, the affiliated store supplies the predetermined support recipient or the support system 100 with support goods or a price corresponding to the support goods.

FIG. 3 is a diagram illustrating an example of information stored in the affiliated store information storage unit 114. The information stored in the affiliated store information storage unit 114 includes, for example, an affiliated store ID and affiliated store name information. The affiliated store ID is affiliated store identification information for identifying an affiliated store who uses the support system 100. The affiliated store name information is information indicating the name of the affiliated store.

The correspondence storage unit 115 stores preset correspondence information. The correspondence information is information indicating a correspondence among product-or-the-like information indicating a product or the like, support goods information indicating support goods to be supplied to a predetermined support recipient, and affiliated store information indicating an affiliated store that bears the support goods. That is, the correspondence information is information indicating the support goods corresponding to a product or the like purchased by the user and the affiliated store that bears the support goods.

The product-or-the-like information is information indicating a product or the like, and may be, for example, information indicating the name of a product or the like such as “beverage B” or information for identifying a product or the like (for example, a product code or the like).

The support goods information is information indicating support goods to be supplied to a predetermined support recipient. The support goods are goods supplied to the support recipient and may be, for example, money, clothes, ingredients, stationery, daily necessities, electronic money, points, a time, and the like. The present invention is not limited thereto. For example, when the support goods is a “time”, support supplied from an affiliated store to a predetermined support recipient may be support for supplying a labor force corresponding to the time indicated by the support goods information. The support goods information may be, for example, information indicating a fixed amount of goods such as “1 yen” or may be information indicating a ratio of the price of goods or the like such as “1%”.

The support goods information may be information indicating support goods supplied when a predetermined condition is satisfied. In this case, the support goods information may include condition information regarding a predetermined condition. The predetermined condition may be, for example, a condition regarding whether the number of products purchased or the total amount within a predetermined period is equal to or more than a predetermined threshold.

The affiliated store ID is information indicating an affiliated store that bears the support goods and is, for example, an affiliated store ID.

The correspondence information may be information generated by the support system 100 or may be information acquired from the second system. A plurality of pieces of product-or-the-like information may correspond to one affiliated store ID, and a plurality of affiliated store IDs may correspond to one piece of product-or-the-like information. Here, a case where a plurality of affiliated store IDs correspond to one piece of product-or-the-like information is, for example, a case where an ID of an affiliated store that manufactures a container and an ID of an affiliated store that manufactures a beverage correspond to the product-or-the-like information indicating a packaged beverage when a product or the like is the packaged beverage.

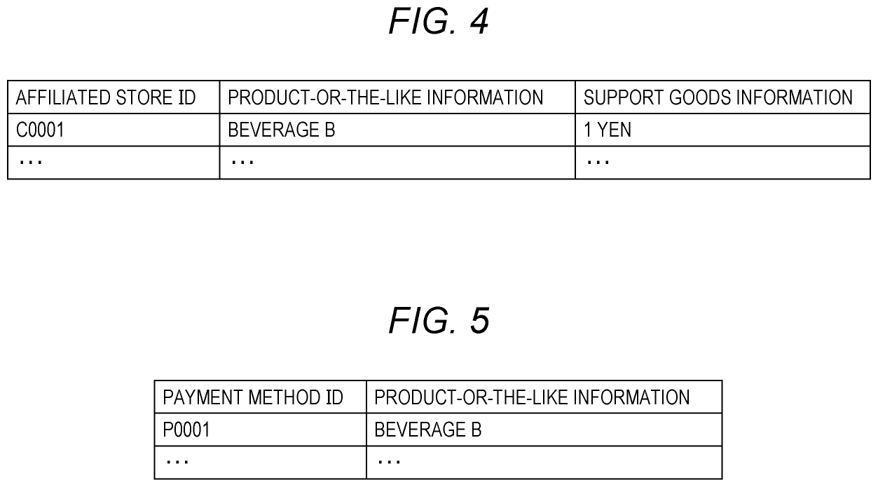

FIG. 4 is a diagram illustrating an example of information stored in the correspondence storage unit 115. The information stored in the correspondence storage unit 115 includes, for example, an affiliated store ID, product-or-the-like information, and support goods information.

The purchase information acquisition unit 121 acquires purchase information regarding purchase of a product or the like by the user from the payment system 400 and stores the purchase information in the purchase information storage unit 122. The purchase information is information regarding a payment method of the user and purchase details (a purchase amount, content of purchased products or the like, a purchase date, a purchase store, and the like).

The payment system 400 generates purchase information based on the payment method of the user and purchase details (a purchase amount, content of purchased products, a purchase date, a purchase store, and the like). The purchase information acquisition unit 121 acquires the purchase information from the payment system 400.

The purchase information acquisition unit 121 may acquire only the purchase information purchased in accordance with the payment method indicated by the payment method information included in the user information based on the user information stored in the user information storage unit 112. Accordingly, the purchase information acquisition unit 121 and the payment system 400 can transmit and receive only the purchase information necessary for the process of the support system 100.

The purchase information acquisition unit 121 may process the acquired purchase information and then store the processed purchase information in the purchase information storage unit 122. At this time, for example, the purchase information acquisition unit 121 may specify the user corresponding to the payment method based on the user information stored in the user information storage unit 112, perform a process of associating the user ID or the payment method ID with the purchase information, and then store them in the purchase information storage unit 122. Accordingly, the support system 100 can manage the purchase information for each user.

The purchase information acquisition unit 121 may also acquire purchase information other than the purchase information purchased in accordance with the payment method indicated by the payment method information included in the user information, store the acquired purchase information in the purchase information storage unit 122, and process the acquired purchase information at the time of storage.

Acquiring the purchase information by the purchase information acquisition unit 121 and storing the purchase information in the purchase information storage unit 122 may be performed each time at which the user makes a purchase or may be performed at regular intervals. In addition, the process may be performed at any timing in response to a request from the support system 100 or the payment system 400.

FIG. 5 is a diagram illustrating an example of information stored in the purchase information storage unit 122. The information stored in the purchase information storage unit 122 includes, for example, a payment method ID and product-or-the-like information. The information stored in the purchase information storage unit 122 may include a user ID instead of the payment method ID or may include both the payment method ID and the user ID. In addition, information regarding the details of purchase (a purchase amount, a purchase date, a purchase store, and the like.) may be included.

The support execution information generation unit 131 generates support execution information in which the support recipient information, the support goods information, and the affiliated store information are associated with one another based on the purchase information and the correspondence information, and stores the generated support execution information in the support execution information storage unit 132.

The support execution information is information indicating support goods which a corresponding affiliated store substantially bears, and a support recipient for which the support goods are supplied. Here, the affiliated store may directly supply the support goods to the support recipient or may indirectly supply the support goods to the support recipient through the support system 100.

When an affiliated store directly supplies support goods to a support recipient, an information processing system (for example, second system 300) of the affiliated store supplies the corresponding support recipient with the corresponding support goods based on the support execution information. When an affiliated store indirectly supplies support goods to a support recipient through the support system 100, the support execution unit 133 to be described below supplies corresponding support goods to the corresponding support recipient based on the support execution information.

When the support execution information is generated, for example, the support execution information generation unit 131 specifies a user (for example, the user ID) corresponding to the purchase information based on the purchase information and the user information, and extracts support recipient information corresponding to the user. Then, the support execution information generation unit 131 generates support execution information based on the correspondence information and the extracted support recipient information.

When the support execution information is generated, for example, the support execution information generation unit 131 may specify the support goods information corresponding to the purchase information based on the purchase information and the correspondence information, supply the first system 200 with the support goods information to be aggregated as necessary, and then generate the support execution information based on the support recipient information acquired by the user information acquisition unit 111. Accordingly, the user can select the support recipient after ascertaining the support goods associated with the user.

The support execution information generation unit 131 may generate support execution information corresponding to purchase information that satisfies a predetermined condition when the support goods information included in the correspondence information is information indicating support goods supplied when the predetermined condition is satisfied. When a plurality of affiliated store IDs correspond to one piece of product-or-the-like information included in the correspondence information, the support execution information generation unit 131 may generate a plurality of pieces of support execution information corresponding to the plurality of affiliated store IDs from one piece of purchase information.

Any timing at which the support execution information is generated by the support execution information generation unit 131 can be set. The support execution information may be generated by the support execution information generation unit 131 whenever the purchase information is acquired or at regular intervals.

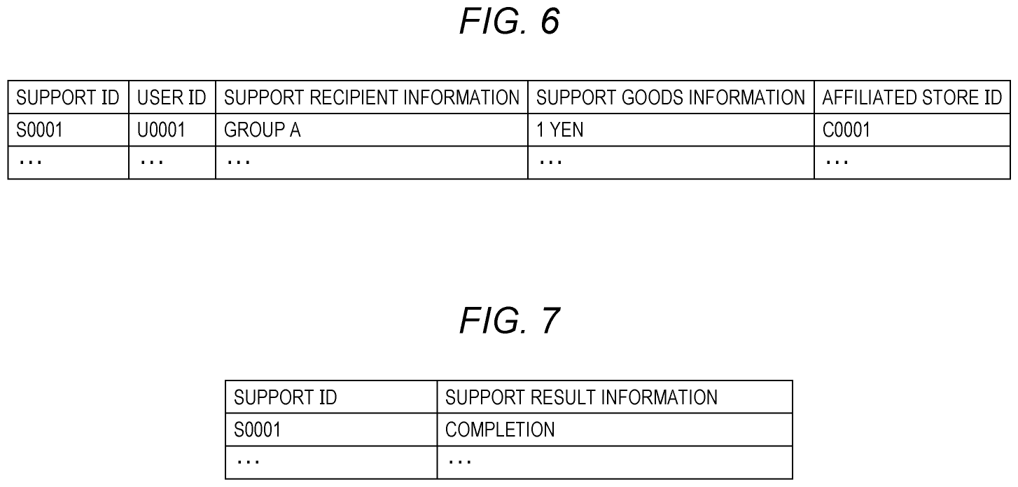

FIG. 6 is a diagram illustrating an example of information stored in the support execution information storage unit 132. The information stored in the support execution information storage unit 132 includes, for example, a support ID, a user ID, support recipient information, support goods information, and an affiliated store ID. Here, the support ID is support execution information identification information for identifying the support execution information.

The information stored in the support execution information storage unit 132 may be stored in a format corresponding to each piece of purchase information or may be information aggregated for each specific item (for example, the affiliated store ID). Further, the information stored in the support execution information storage unit 132 may further include product-or-the-like information or may be information aggregated for each piece of product-or-the-like information.

Based on the support execution information, the support execution unit 133 generates support result information indicating an execution result of the support by supplying corresponding support goods to a corresponding support recipient and stores the support result information in the support result information storage unit 136. That is, the support execution unit 133 executes support corresponding to the support execution information.

The support result information is information indicating an execution result of the support corresponding to the support execution information and is, for example, information indicating that the supply of the support goods and the preparation thereof is completed. The support result information may include information indicating the content of the corresponding support (support recipients, support goods, and the like) in addition to the information indicating that the supply of the support goods or the preparation thereof is completed. The support result information may include information indicating an execution result of support performed based on the support execution information supplied from the support execution information supply unit 134, such as information indicating that the support recipient has received the support goods.

Any timing of the support execution by the support execution unit 133 can be set. The support execution by the support execution unit 133 may be executed at a certain periodic timing, for example, every end of month or may be executed at a timing designated by the user, the affiliated store, or the support recipient.

The support execution information supply unit 134 supplies the support execution information to the second system 300. The second system 300 supplies corresponding support goods to the corresponding support recipient based on the supplied support execution information.

The support result information acquisition unit 135 acquires support result information indicating an execution result of support performed based on the support execution information supplied from the support execution information supply unit 134 from at least one of the second system 300 and the information processing system of the support recipient and stores the support result information in the support result information storage unit 136.

The support system 100 may perform subsequent processes when the support result information acquisition unit 135 acquires the support result information from the information processing system of the support recipient as necessary. Accordingly, the support system 100 can prevent an affiliated store from supplying false support result information.

The second system 300 may supply the support execution information to another information processing system or may supply support result information generated by the other information processing system to the support result information acquisition unit 135. In this case, the support may be executed by the other information processing system.

The support result information storage unit 136 stores at least one of the support result information generated by the support execution unit 133 and the support result information acquired by the support result information acquisition unit 135. FIG. 7 is a diagram illustrating an example of information stored in the support result information storage unit 136. The information stored in the support result information storage unit 136 includes, for example, a support ID and support result information. The support result information stored in the support result information storage unit 136 may include information indicating the content of the corresponding support (a support recipient, support goods, and the like) in addition to the information indicating that the supply of the support goods or the preparation thereof is completed.

The support result information supply unit 137 supplies the support result information to the first system 200. The support result information supply unit 137 may supply the first system 200 with support result information including information indicating the content of the corresponding support (support recipients, support goods, and the like).

The support result information supply unit 137 may perform predetermined statistical processing on the support result information and subsequently supply the support result information to the first system 200. For example, the support result information supply unit 137 may supply information obtained by aggregating support goods for each support recipient based on information indicating the content of support (the support recipients, the support goods, and the like) included in the support result information. Accordingly, the user can ascertain the support situation for each support recipient.

The support goods acquisition unit 138 acquires support goods corresponding to the support execution information or the support result information or a price corresponding to the support goods from the second system 300 based on the support execution information or the support result information.

Here, the price corresponding to the support goods may be the same type of goods as the support goods or may be a different type of goods from the support goods. That is, when the support goods supplied by the support execution unit 133 are actual articles such as clothes and ingredients, the price corresponding to the support goods may be money corresponding to the clothes, ingredients, and the like.

When an affiliated store indirectly supplies support goods to a support recipient through the support system 100, the support system 100 acquires the corresponding support goods or the price corresponding to the support goods from the second system 300 before or after the execution of the support by the support execution unit 133, and thus the affiliated store can bear the support. Thus, the support goods acquisition unit 138 acquires the corresponding support goods or the price corresponding to the support goods from the second system 300.

The process by the support goods acquisition unit 138 may be performed based on the support execution information before the execution of the support by the support execution unit 133 or may be performed based on the support execution information or the support result information after the execution of the support. The process by the support goods acquisition unit 138 may be performed whenever the support is executed by the support execution unit 133, or may be performed at regular intervals.

The purchase information supply unit 141 supplies the purchase information stored in the purchase information storage unit 122 to the second system 300.

When an affiliated store supplies the support goods corresponding to the price for the supply of the purchase information to a support recipient of the user corresponding to the purchase information, the purchase information supply unit 141 may supply the purchase information to the second system 300 corresponding to the affiliated store. Hereinafter, this processing will be specifically described.

The purchase information is useful information that can be used for marketing of an affiliated store and is personal information regarding a behavior of the user. Therefore, it is conceivable that the user requests a certain price from the affiliated store when user's purchase information is supplied. In addition, a need for the user to supply the price acquired from the affiliated store as support goods to a support recipient desired by the user is assumed.

Thus, the user desires to supply his or her purchase information only to an affiliated store that supplies support goods corresponding to a price of his/her purchase information to a support recipient desired by the user. That is, when the affiliated store supplies support goods corresponding to the price for the supply of the purchase information to the support recipient of the user corresponding to the purchase information, the purchase information supply unit 141 supplies the purchase information to the second system 300 corresponding to the affiliated store. The support system 100 may supply the purchase information to some or all of the affiliated stores that supply the support goods corresponding to the price for the purchase information of the user to the support recipient desired by the user, or may supply the purchase information to affiliated stores other than the affiliated stores that supply the support goods corresponding to the price for the purchase information of the user to the support recipient desired by the user, based on a setting operation by the user through the first system 200.

For example, the purchase information supply unit 141 specifies an affiliated store that supplies the support goods corresponding to the price for the supply of the purchase information to the support recipient of the user corresponding to the purchase information based on the support recipient information and the support goods information included in the support execution information stored in the support execution information storage unit 132 or the support result information stored in the support result information storage unit 136. Then, the purchase information supply unit 141 supplies the purchase information to the second system corresponding to the specified affiliated store.

The advertisement information acquisition unit 142 acquires advertisement information indicating an advertisement related to an affiliated store from the second system 300 or an external information processing system.

Here, the advertisement information may be information regarding an advertisement related to a product or a service of an affiliated store or may be information suggesting purchase of a financial product related to the affiliated store. The external information processing system that supplies the advertisement information to the advertisement information acquisition unit 142 may be, for example, an information processing system of an advertisement agency or an advertisement distributor that handles advertisements, or an information processing system of a securities company or the like that handles financial products.

The advertisement information supply unit 143 supplies advertisement information of an affiliated store that supplies predetermined support goods to the support recipient indicated by the support recipient information to the first system 200 corresponding to the support recipient information.

When the support system 100 is used, the user may receive a certain advertisement. At that time, the advertisement of the affiliated store supplying the support goods to the support recipient desired by the user is highly likely to be an advertisement having affinity for the user. Therefore, the supply of the advertisement of the affiliated store can be an advertisement supply useful for the user and can be an advertisement supply having a high advertising effect for the affiliated store. Thus, the advertisement information supply unit 143 supplies the first system 200 with advertisement information of an affiliated store that supplies support goods to a support recipient of the user.

When the first system 200 is a user terminal, the advertisement information supply unit 143 supplies advertisement information of an affiliated store that supplies support goods to a support recipient of the user to the corresponding user terminal. When the first system 200 is an information processing system that controls a service used by the user, the advertisement information supply unit 143 supplies, for example, advertisement information to the first system in association with the user ID. Accordingly, the first system can supply the advertisement information to the corresponding user terminal.

The advertisement information supply unit 143 specifies an affiliated store that supplies support goods to a support recipient of the user based on, for example, support recipient information and support goods information included in the support execution information stored in the support execution information storage unit 132 or the support result information stored in the support result information storage unit 136. Then, the advertisement information supply unit 143 supplies the advertisement information of the specified affiliated store to the first system 200.

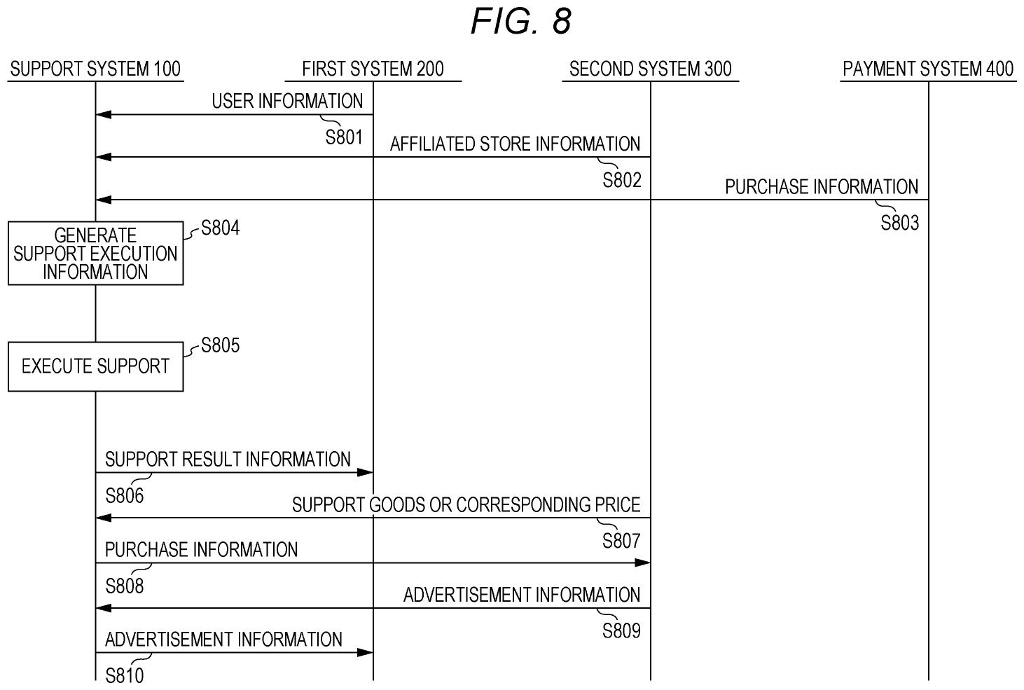

FIG. 8 is a flowchart illustrating an example of a process in the support system 100. The process illustrated in FIG. 8 is a process when the support system 100 executes support.

First, the user information acquisition unit 111 acquires user information from the first system 200 (S801). The affiliated store information acquisition unit 113 acquires the affiliated store information from the second system 300 (S802). The purchase information acquisition unit 121 acquires the purchase information from the payment system 400 (S803). Note that the user information acquisition unit 111 may acquire the user information before the support execution information is generated by the support execution information generation unit 131 to be described below.

Subsequently, the support execution information generation unit 131 generates support execution information based on the purchase information and the correspondence information (S804). Then, the support execution unit 133 executes support based on the support execution information (S805).

The support result information supply unit 137 supplies the support result information to the first system 200 (S806). The support goods acquisition unit 138 acquires support goods corresponding to the support execution information or the support result information or a price corresponding to the support goods from the second system 300 based on the support execution information or the support result information (S807).

The purchase information supply unit 141 supplies the purchase information to second system 300 (S808). The advertisement information acquisition unit 142 acquires the advertisement information from the second system (S809). The advertisement information supply unit 143 supplies the advertisement information to the first system 200 (S810).

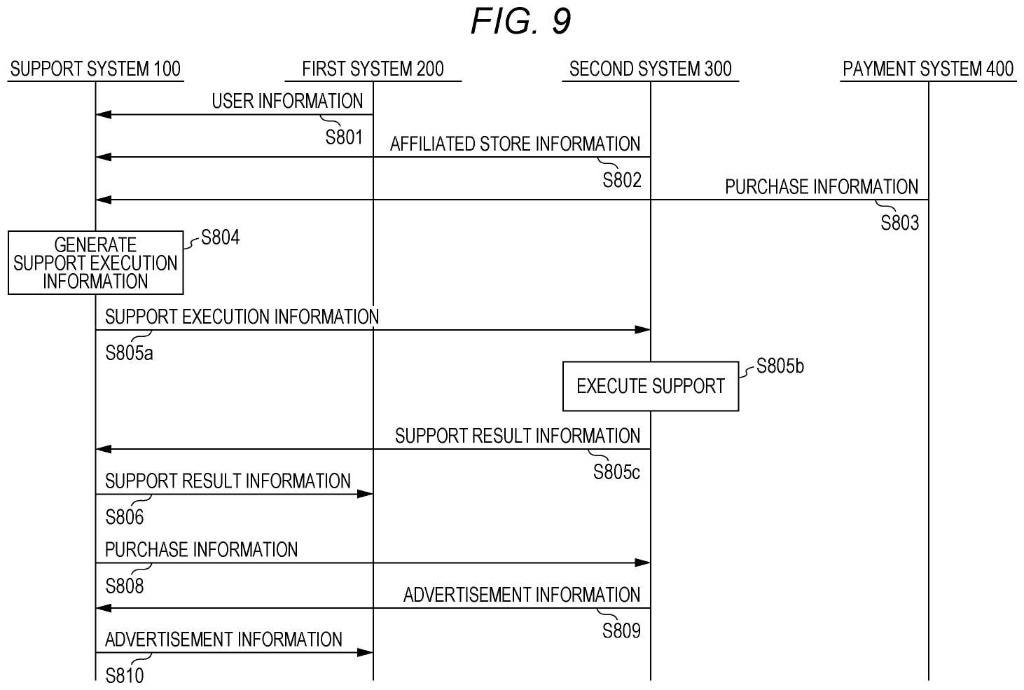

FIG. 9 is a flowchart illustrating an example of a process in the support system 100. The process illustrated in FIG. 9 is a process when the second system 300 executes support. FIG. 9 corresponds to the flowchart illustrated in FIG. 8, but the process of S805 is different, and the process of S807 is unnecessary.

Specifically, when the second system 300 executes support, the support execution information supply unit 134 supplies support execution information to the second system (S805a). Thereafter, for example, the support is executed in the second system 300 (S805b). Then, the support result information acquisition unit 135 acquires support result information from the second system 300 (S805c). The second system 300 may supply the support execution information to another information processing system, the support may be executed by the other information processing system, and the second system may supply the support result information generated by the other information processing system to the support result information acquisition unit 135. Further, the support result information acquisition unit 135 may acquire the support result information from the information processing system of the support recipient.

The embodiment of the present invention has been described above. The support system 100 can generate the support execution information in which support goods and a support recipient for which the user desires support are associated based on the purchase information and the user information set in advance by the user. Accordingly, the support system 100 can manage and effectively utilize data regarding the support recipient and a support situation of the user. The user can perform a support activity with a low hurdle for participation in the support activity and a high satisfaction level.

The support system 100 can supply support goods to a corresponding support recipient based on the support execution information. Accordingly, the support system 100 can effectively utilize the data regarding the support activity in execution of indirect support by the user and the affiliated store through the support system 100.

The support system 100 can supply support execution information to the second system 300. Accordingly, the affiliated store can effectively utilize the data regarding a support activity in execution of support in the second system 300 or another information processing system.

The support system 100 can supply the support result information to the first system 200. Accordingly, the support system 100 can supply the user with a highly satisfactory support activity by effectively utilizing the data regarding the support activity and presenting the result of the support through the support system 100 to the user.

The support system 100 can acquire the support goods corresponding to the support execution information or the support result information or a price corresponding to the support goods from the second system 300. Accordingly, the support system 100 can cause the second system 300 to bear the support indirectly performed by the second system 300 through the support system 100 by effectively utilizing the data regarding the support activity.

The support system 100 can supply purchase information to the second system 300. Accordingly, the second system 300 can effectively utilize the purchase information, which is the information regarding the support activities, for corporate activities such as sales activities.

When an affiliated store supplies support goods corresponding to a price for the supply of the purchase information to a support recipient of the user corresponding to the purchase information, the support system 100 can supply the purchase information to the second system 300 corresponding to the affiliated store. Accordingly, the user can effectively utilize his or her purchase information regarding the support activity for the support activity.

The support system 100 can supply the first system 200 with advertisement information regarding the affiliated store that supplies support goods to the support recipient of the user. Accordingly, the user can receive an advertisement having high affinity with himself or herself by effectively utilizing information regarding the support activity and the affiliated store can supply the advertisement to the user having a high advertising effect.

The above-described embodiments can facilitate understanding of the present invention and are not intended to limit the present invention. The present invention can be modified and improved without departing from the gist of the invention, and equivalents thereof are also included in the present invention.

What is claimed is:

1. A support system comprising:
a user information acquisition unit configured to acquire, from a first system that is an external information processing system, user information including payment method information regarding a payment method when a user purchases a product or service and support recipient information indicating a support recipient for which the user desires support;
a purchase information acquisition unit configured to acquire purchase information regarding purchase of a product or a service by the user in accordance with the payment method from a payment system that manages the purchase information; and
a support execution information generation unit configured to generate support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.

2. The support system according to claim 1, further comprising: a support execution unit configured to supply the support goods to a support recipient indicated by the support recipient information based on the support execution information and generate support result information indicating an execution result of the support corresponding to the support execution information.

3. The support system according to claim 1, further comprising:
a support execution information supply unit configured to supply the support execution information to a second system that is an information processing system of the affiliated store; and
a support result information acquisition unit configured to acquire support result information indicating an execution result of support corresponding to the support execution information from at least one of the second system and an information processing system of the support recipient.

4. The support system according to claim 1, further comprising: a support result information supply unit configured to supply the support result information to the first system.

5. The support system according to claim 2, further comprising: a support goods acquisition unit configured to acquire the support goods corresponding to the support execution information or the support result information, or a price corresponding to the support goods from the second system that the information processing system of the affiliated store based on the support execution information or the support result information.

6. The support system according to claim 1, further comprising: a purchase information supply unit configured to supply the purchase information of the user to the second system that is the information processing system of the affiliated store.

7. The support system according to claim 6, wherein the purchase information supply unit supplies the purchase information of the user to the second system when the affiliated store supplies the support goods corresponding to a price for the purchase information of the user to the support recipient indicated by the support recipient information.

8. The support system according to claim 1, further comprising: an advertisement information supply unit configured to supply the first system with advertisement information indicating an advertisement related to the affiliated store that supplies the support goods to the support recipient indicated by the support recipient information.

9. A support method comprising:
by a computer,
acquiring, from a first system that is an external information processing system, user information including payment method information regarding a payment method when a user purchases a product or service and support recipient information indicating a support recipient for which the user desires support;
acquiring purchase information regarding purchase of a product or a service by the user in accordance with the payment method from a payment system that manages the purchase information; and
generating support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.

10. A non-transitory computer-readable recording medium storing a support program for causing a computer to implement:
a user information acquisition unit configured to acquire, from a first system that is an external information processing system, user information including payment method information regarding a payment method when a user purchases a product or service and support recipient information indicating a support recipient for which the user desires support;
a purchase information acquisition unit configured to acquire purchase information regarding purchase of a product or a service by the user in accordance with the payment method from a payment system that manages the purchase information; and
a support execution information generation unit configured to generate support execution information in which the support recipient information, support goods information indicating support goods supplied to a predetermined support recipient, and affiliated store information indicating an affiliated store that bears the support goods are associated with each other based on the user information, the purchase information, and a preset correspondence among product-or-the-like information indicating the product or the service, the support goods information, and the affiliated store information.
